(19) United States
(12) Patent Application Publication
(10) Pub. No.: US 2005/0062293 A1
(43) Pub. Date: Mar. 24, 2005

(54) Switch device for door

(76) Inventors: Chung-Shan Shen, Taichung (TW); Chi-Ching Shen, Taichung (TW)

Correspondence Address: Chung-Shan Shen, 58, MA YUAN WEST ST., TAICHUNG, TW

(21) Appl. No.: 10/666,984

(22) Filed: Sep. 19, 2003

(51) Int. Cl. E05C 1/02

(52) U.S. Cl. 292/137

(57) ABSTRACT

A switch device includes a male assembly, and a female assembly. The male assembly includes a first fixing seat, a first operation socket, a first locking seat, and a retractable rod. The female assembly includes a second fixing seat, a second operation socket, and a second locking seat. Thus, the male assembly can be detached from the female assembly rapidly, thereby facilitating the user operating the switch device to open the door of the refrigerator. In addition, the user only needs to press the door of the refrigerator so as to open the door of the refrigerator easily and conveniently, thereby facilitating the user opening the door of the refrigerator.

### BACKGROUND OF THE INVENTION

1. Field of the Invention

The present invention relates to a switch device, and more particularly to a switch device for the door of a refrigerator or the like.

2. Description of the Related Art

A conventional refrigerator primarily comprises a cabinet, and a door pivotally mounted on the cabinet. The door has a periphery provided with a magnetic gasket, and the cabinet has a periphery provided with a magnetic body attracted by the magnetic gasket of the door, so that the door is closely combined with the cabinet.

However, the magnetic gasket of the door is easily worn out or stripped due to the moisture, so that the cold air easily leaks outward from the door, thereby decreasing the cooling effect of the refrigerator. In addition, the user has to exert a larger force to overcome the magnetic force applied by the magnetic gasket of the door so as to open the door, thereby greatly causing inconvenience to the user when both of his two hands hold food.

### SUMMARY OF THE INVENTION

The primary objective of the present invention is to provide a switch device for locking and unlocking the door of a refrigerator or the like.

Another objective of the present invention is to provide a switch device, wherein the male assembly can be detached from the female assembly rapidly, thereby facilitating the user operating the switch device to open the door of the refrigerator.

A further objective of the present invention is to provide a switch device, wherein the user only needs to press the door of the refrigerator so as to open the door of the refrigerator easily and conveniently, thereby facilitating the user opening the door of the refrigerator.

In accordance with the present invention, there is provided a switch device, comprising a male assembly, and a female assembly, wherein:
the male assembly includes a first fixing seat, a first operation socket, a first locking seat, and a retractable rod, wherein:
the first fixing seat of the male assembly has a side provided with a plurality of flexible locking hooks each having a distal end formed with a wedge-shaped catch portion;
the first operation socket of the male assembly is mounted on the first fixing seat and has a periphery formed with a plurality of positioning slots for movably mounting the catch portion of a respective one of the locking hooks of the first fixing seat;
the first locking seat of the male assembly is secured on the first fixing seat and has a side provided with a plurality of flexible locking pawls each having an outer wall formed with a groove and an inner wall formed with a catch portion;
the retractable rod of the male assembly is movably mounted in the first operation socket and the first fixing seat and has a first end formed with a first annular groove for slidably mounting the catch portion of each of the locking pawls of the first locking seat and a tapered second end formed with a tapered second annular groove;
the female assembly includes a second fixing seat, a second operation socket, and a second locking seat, wherein:
the second fixing seat of the female assembly has a side provided with a plurality of flexible locking hooks each having a distal end formed with a wedge-shaped catch portion;
the second operation socket of the female assembly is mounted on the second fixing seat and has a periphery formed with a plurality of positioning slots for movably mounting the catch portion of a respective one of the locking hooks of the second fixing seat; and
the second locking seat of the female assembly is secured on the second fixing seat and has a side provided with a plurality of flexible locking pawls each having an outer wall formed with a groove.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a switch device in accordance with the preferred embodiment of the present invention;

FIG. 1A is a plan cross-sectional view of a first operation socket of the switch device taken along line 1A-1A as shown in FIG. 1;

FIG. 1B is a plan cross-sectional view of a second operation socket of the switch device taken along line 1B-1B as shown in FIG. 1;

FIG. 1C is a perspective view of a first fixing seat of the switch device as shown in FIG. 1;

FIG. 2 is a partially plan cross-sectional assembly view of the switch device as shown in FIG. 1;

FIG. 3 is a perspective view showing the switch device being used for a refrigerator;

FIG. 3A is a partially enlarged view of a male assembly of the switch device as shown in FIG. 3;

FIG. 3B is a partially enlarged view of a female assembly of the switch device as shown in FIG. 3;

FIG. 4 is a schematic operational view of the switch device as shown in FIG. 2;

FIG. 5 is a schematic operational view of the switch device as shown in FIG. 4;

FIG. 6 is a schematic operational view of the switch device as shown in FIG. 5;

FIG. 7 is a schematic operational view of the switch device as shown in FIG. 6;

FIG. 8 is a schematic operational view of the switch device as shown in FIG. 7;

FIG. 9 is a schematic operational view of the switch device as shown in FIG. 8;

FIG. 10 is a schematic operational view of the switch device as shown in FIG. 9; and

FIG. 11 is a partially plan cross-sectional assembly view of a switch device in accordance with another embodiment of the present invention.

### DETAILED DESCRIPTION OF THE INVENTION

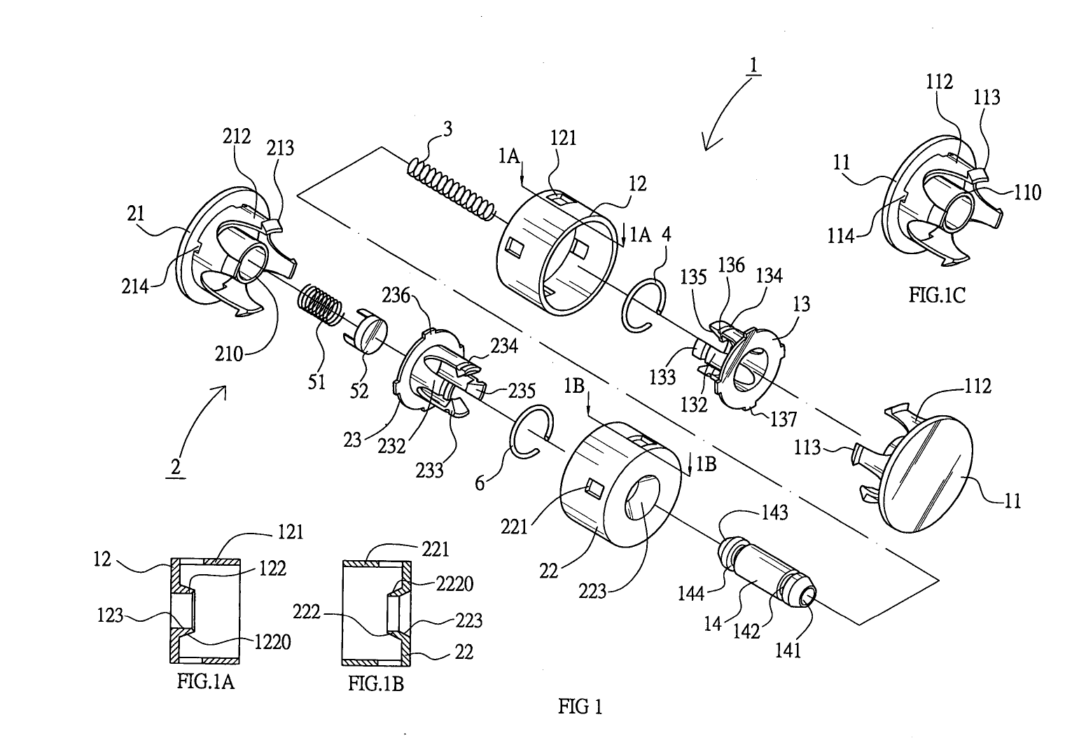

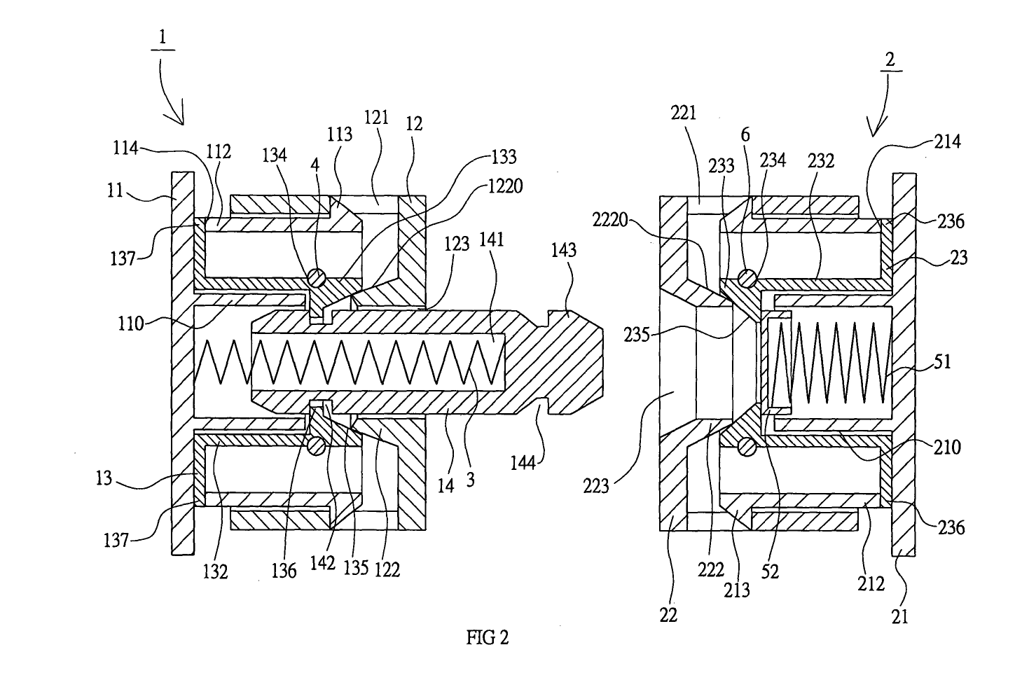

Referring to the drawings and initially to FIGS. 1 and 2, a switch device in accordance with the preferred embodiment of the present invention is used for locking and unlocking the door of a refrigerator or the like and comprises a male assembly 1, and a female assembly 2.

The male assembly 1 includes a first fixing seat 11, a first operation socket 12, a first locking seat 13, and a retractable rod 14.

The first fixing seat 11 of the male assembly 1 has a side provided with a cylinder 110 (see FIG. 1C) and a plurality of flexible locking hooks 112 surrounding the cylinder 110 and each having a distal end formed with a wedge-shaped catch portion 113. The first fixing seat 11 of the male assembly 1 has a periphery formed with a plurality of locking recesses 114 (see FIG. 1C).

The first operation socket 12 of the male assembly 1 is mounted on the first fixing seat 11 and has a periphery formed with a plurality of positioning slots 121 for movably mounting the catch portion 113 of a respective one of the locking hooks 112 of the first fixing seat 11. The first operation socket 12 of the male assembly 1 has an end face provided with a conical barrel 122 (see FIG. 1A) having an inner wall formed with an axial hole 123 and an outer wall formed with a tapered face 1220.

The first locking seat 13 of the male assembly 1 is secured on the first fixing seat 11 and has a periphery formed with a plurality of positioning lugs 137 each inserted into a respective one of the locking recesses 114 of the first fixing seat 11. The first locking seat 13 of the male assembly 1 has a side provided with a plurality of flexible locking pawls 132 each having an outer wall formed with a groove 134 and an inner wall formed with a catch portion 136. Each of the locking pawls 132 of the first locking seat 13 has a distal end 133 formed with an inclined face 135 rested on the tapered face 1220 of the conical barrel 122 of the first operation socket 12.

The male assembly 1 further includes a C-shaped spring 4 mounted in the groove 134 of each of the locking pawls 132 of the first locking seat 13 for urging each of the locking pawls 132 of the first locking seat 13 radially inward.

The retractable rod 14 of the male assembly 1 is movably mounted in the conical barrel 122 of the first operation socket 12 and the cylinder 110 of the first fixing seat 11. The retractable rod 14 of the male assembly 1 has a first end formed with a first annular groove 142 for slidably mounting the catch portion 136 of each of the locking pawls 132 of the first locking seat 13 and a tapered second end 143 formed with a tapered second annular groove 144. The retractable rod 14 of the male assembly 1 has an inside formed with a receiving chamber 141 for receiving a first compression spring 3 which is biased between a wall of the receiving chamber 141 and the first fixing seat 11.

The female assembly 2 includes a second fixing seat 21, a second operation socket 22, and a second locking seat 23.

The second fixing seat 21 of the female assembly 2 has a side provided with a cylinder 210 and a plurality of flexible locking hooks 212 surrounding the cylinder 210 and each having a distal end formed with a wedge-shaped catch portion 213. The second fixing seat 21 of the female assembly 2 has a periphery formed with a plurality of locking recesses 214.

The second operation socket 22 of the female assembly 2 is mounted on the second fixing seat 21 and has a periphery formed with a plurality of positioning slots 221 for movably mounting the catch portion 213 of a respective one of the locking hooks 212 of the second fixing seat 21. The second operation socket 22 of the female assembly 2 has an end face provided with a conical barrel 222 (see FIG. 1B) having an inner wall formed with an axial hole 223 and an outer wall formed with a tapered face 2220.

The second locking seat 23 of the female assembly 2 is secured on the second fixing seat 21 and has a periphery formed with a plurality of positioning lugs 236 each inserted into a respective one of the locking recesses 214 of the second fixing seat 21. The second locking seat 23 of the female assembly 2 has a side provided with a plurality of flexible locking pawls 232 each having an outer wall formed with a groove 234. Each of the locking pawls 232 of the second locking seat 23 has a distal end 233 formed with an inclined face 235 rested on the tapered face 2220 of the conical barrel 222 of the second operation socket 22.

The female assembly 2 further includes a C-shaped spring 6 mounted in the groove 234 of each of the locking pawls 232 of the second locking seat 23 for urging each of the locking pawls 232 of the second locking seat 23 radially inward.

The female assembly 2 further includes an urging cap 52 movably mounted in the cylinder 210 of the second fixing seat 21 and rested on the distal end 233 of each of the locking pawls 232 of the second locking seat 23, and a second compression spring 51 mounted in the cylinder 210 of the second fining seat 21 and biased between the urging cap 52 and the second fixing seat 21. Preferably, the second compression spring 51 has an elastic force greater than that of the first compression spring 3.

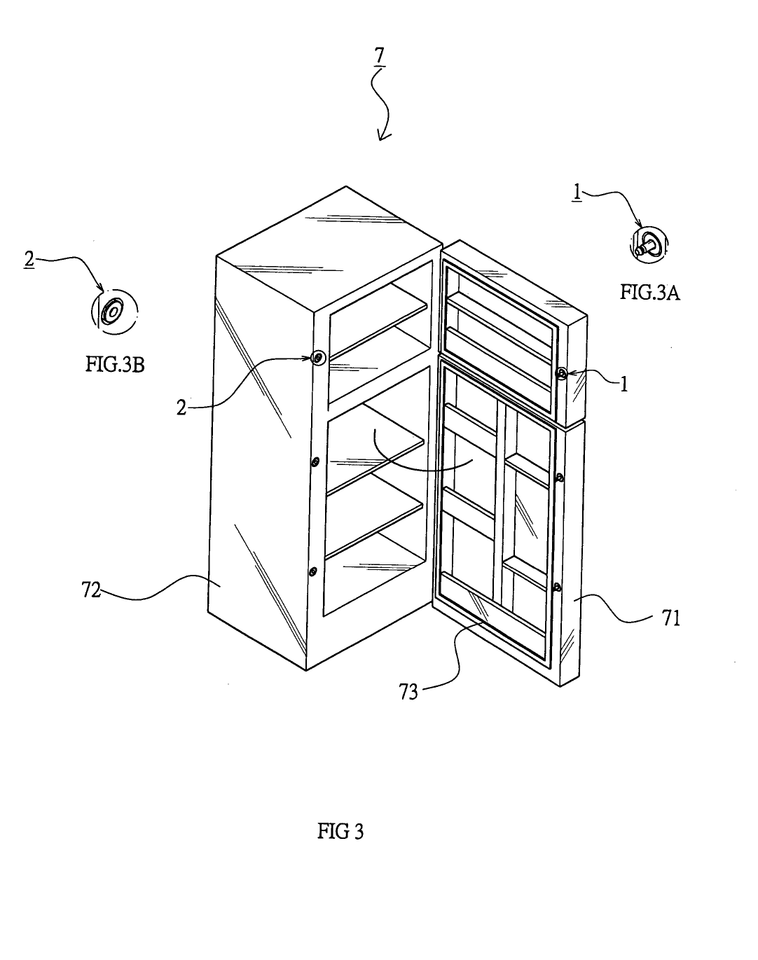

Referring to FIG. 3 with reference to FIGS. 1 and 2, the male assembly 1 (see FIG. 3A) is mounted on the door 71 of the refrigerator 7, and the female assembly 2 (see FIG. 3B) is mounted on the cabinet 72 of the refrigerator 7.

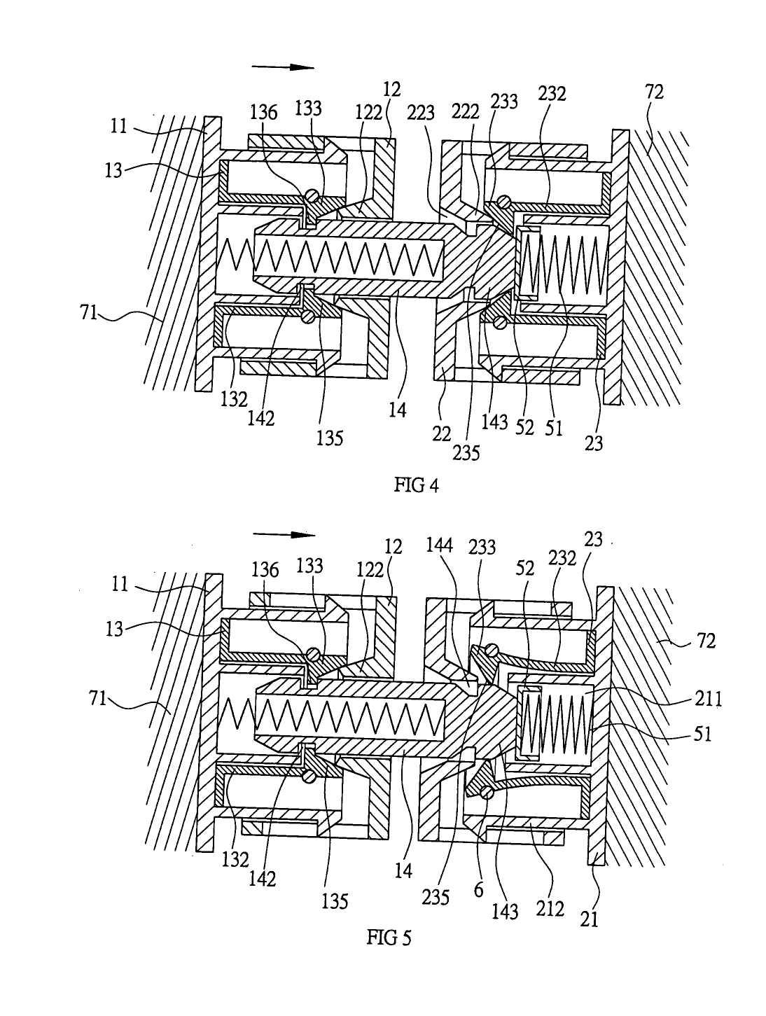

Referring to FIG. 4 with reference to FIGS. 1-3, when the door 71 of the refrigerator 7 is pushed to move toward the cabinet 72 of the refrigerator 7, the male assembly 1 is pushed to move toward the female assembly 2, so that the tapered second end 143 of the retractable rod 14 of the male assembly 1 is inserted into the axial hole 223 of the second operation socket 22 of the female assembly 2 and rested on the inclined face 235 of the distal end 233 of each of the locking pawls 232 of the second locking seat 23 and the urging cap 52.

Then, referring to FIG. 5 with reference to FIGS. 1-4, the tapered second end 143 of the retractable rod 14 of the male assembly 1 is moved successively to press the distal end 233 of each of the locking pawls 232 of the second locking seat 23 to expand outward, and to press the urging cap 52 to move toward the second fixing seat 21 and compress the second compression spring 51.

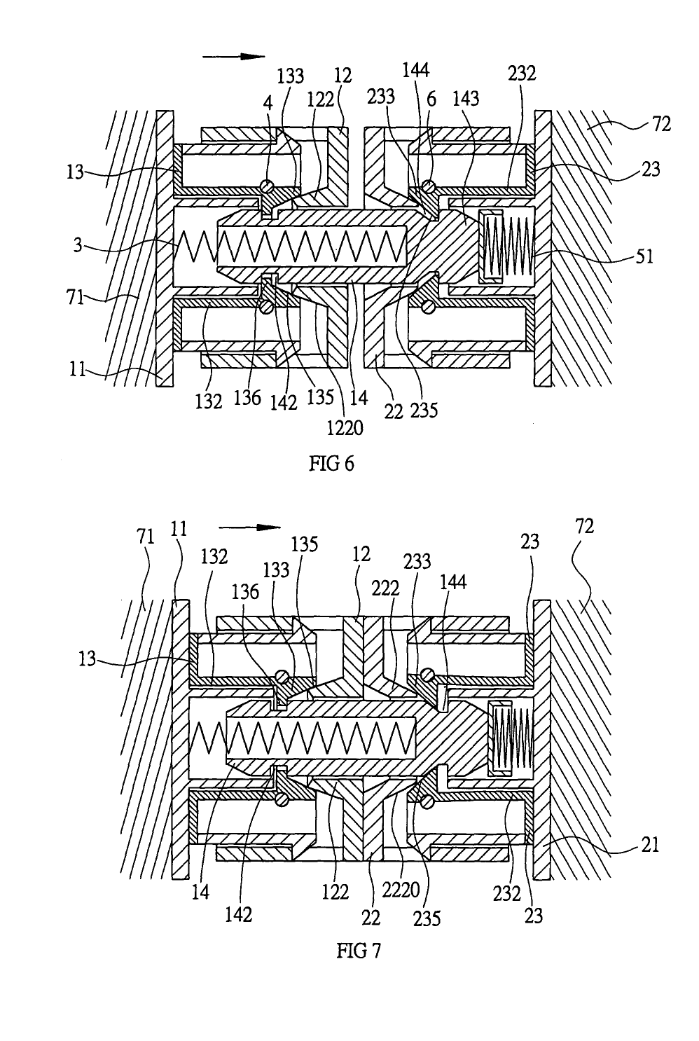

Then, referring to FIG. 6 with reference to FIGS. 1-5, the tapered second end 143 of the retractable rod 14 of the male assembly 1 is moved successively, so that the inclined face 235 of the distal end 233 of each of the locking pawls 232 of the second locking seat 23 is moved into and locked in the second annular groove 144 of the retractable rod 14 of the male assembly 1 by the restoring force of the C-shaped spring 6, thereby closely locking the retractable rod 14 of the male assembly 1 on the second locking seat 23 of the female assembly 2. Thus, the male assembly 1 is closely locked on the female assembly 2, so that the door 71 of the refrigerator 7 is locked on the cabinet 72 of the refrigerator 7.

Referring to FIG. 7 with reference to FIGS. 1-6, when the user wishes to open the door 71 of the refrigerator 7, the door 71 of the refrigerator 7 is pushed to move toward the cabinet 72 of the refrigerator 7, so that the male assembly 1 is pushed to move toward the female assembly 2, and the first locking seat 13 is moved toward the first operation socket 12. At this time, the inclined face 135 of the distal end 133 of each of the locking pawls 132 of the first locking seat 13 is rested on the tapered face 1220 of the conical barrel 122 of the first operation socket 12, so that the first operation socket 12 is pushed by the first locking seat 13 to abut and press the second operation socket 22 which is moved to press the second locking seat 23. At this time, the tapered face 2220 of the conical barrel 222 of the second operation socket 22 is rested on the inclined face 235 of the distal end 233 of each of the locking pawls 232 of the second locking seat 23.

Then, referring to FIG. 8 with reference to FIGS. 1-7, the second operation socket 22 is moved to press the second locking seat 23 successively, so that the distal end 233 of each of the locking pawls 232 of the second locking seat 23 is pressed by the tapered face 2220 of the conical barrel 222 of the second operation socket 22 to expand outward so as to detach from the second annular groove 144 of the retractable rod 14 of the male assembly 1 thereby unlocking the retractable rod 14 of the male assembly 1 from the second locking seat 23 of the female assembly 2. At this time, the inclined face 135 of the distal end 133 of each of the locking pawls 132 of the first locking seat 13 is pressed by the tapered face 1220 of the conical barrel 122 of the first operation socket 12 to expand outward, so that the catch portion 136 of each of the locking pawls 132 of the first locking seat 13 is moved outward to detach from the first annular groove 142 of the retractable rod 14, so that the retractable rod 14 is movable.

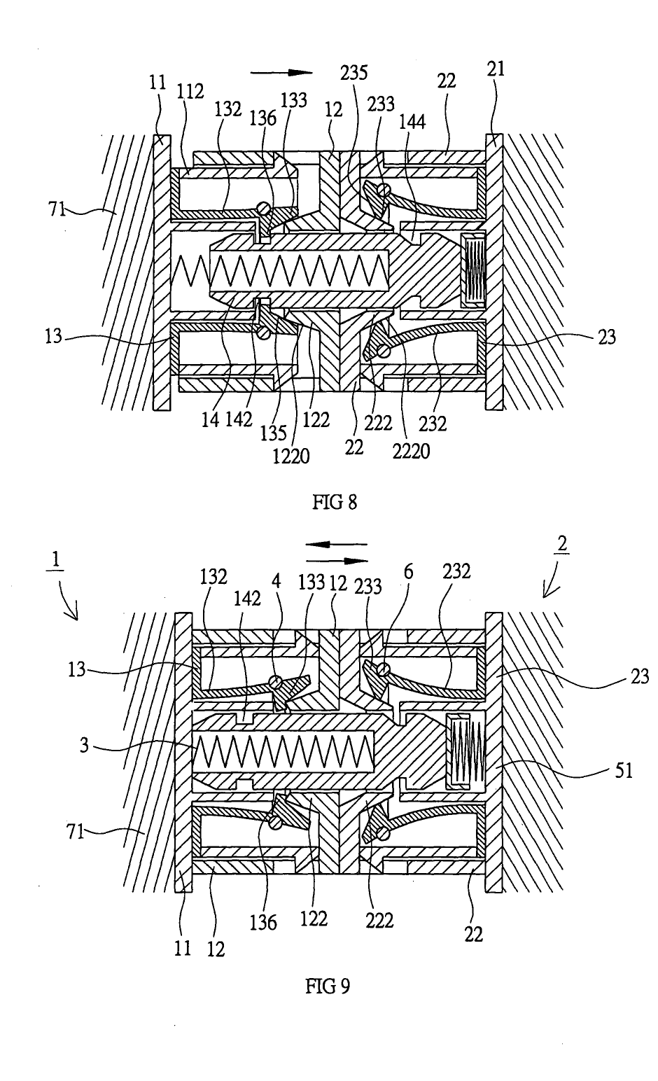

Referring to FIG. 9 with reference to FIGS. 1-8, the second compression spring 51 has an elastic force greater than that of the first compression spring 3, so that the retractable rod 14 is pushed by the second compression spring 51 to move toward the first fixing seat 11 of the male assembly 1, thereby unlocking the male assembly 1 from the female assembly 2, such that the door 71 of the refrigerator 7 is unlocked from the cabinet 72 of the refrigerator 7.

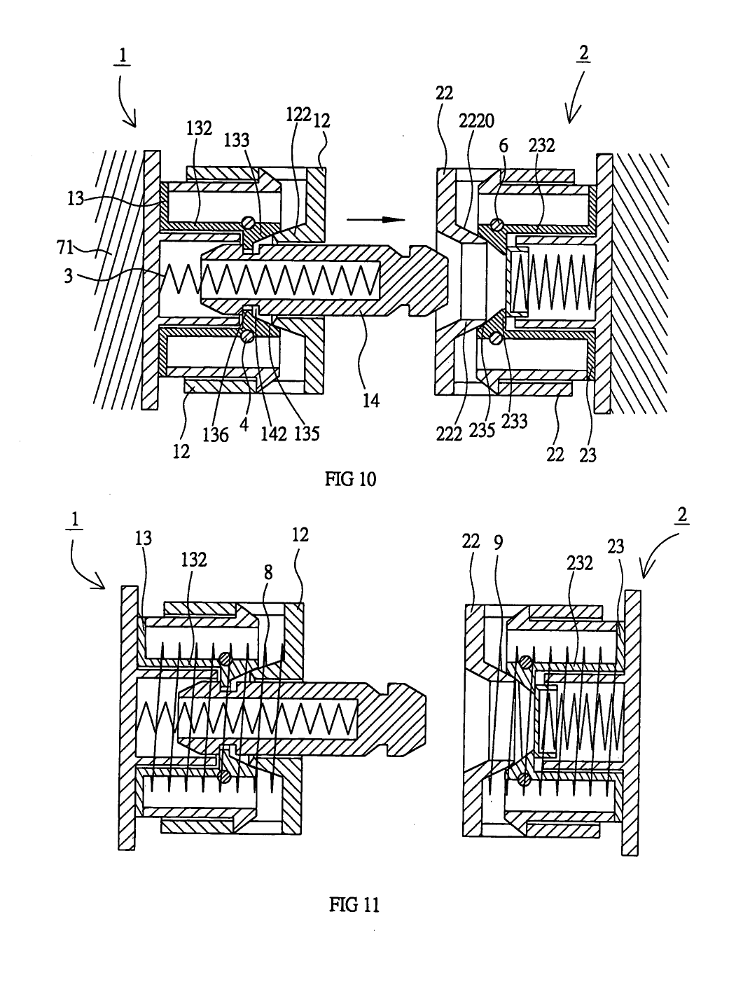

Referring to FIG. 10 with reference to FIGS. 1-9, the retractable rod 14 is pushed outward by the restoring force of the first compression spring 3, so that the inclined face 135 of the distal end 133 of each of the locking pawls 132 of the first locking seat 13 is moved into and locked in the first annular groove 142 of the retractable rod 14 by the restoring force of the C-shaped spring 4. In addition, the distal end 233 of each of the locking pawls 232 of the second locking seat 23 is pressed by the restoring force of the C-shaped spring 6 to push the tapered face 2220 of the conical barrel 222 of the second operation socket 22 to detach from the inclined face 235 of the distal end 233 of each of the locking pawls 232 of the second locking seat 23, so that inclined face 235 of the distal end 233 of each of the locking pawls 232 of the second locking seat 23 can be returned to the original position as shown in FIG. 10.

Again referring to FIG. 3, the door 71 of the refrigerator 7 has a periphery provided with a sponge gasket 73, so that the door 71 of the refrigerator 7 can be pressed and opened easily and conveniently, thereby facilitating the user operating the switch device.

Referring to FIG. 11, a switch device in accordance with another embodiment of the present invention is shown, wherein the male assembly 1 further includes a spring 8 mounted between the first operation socket 12 and the first locking seat 13, so that the first operation socket 12 is moved outward relative to the first locking seat 13 rapidly. In addition, the female assembly 2 further includes a spring 9 mounted between the second operation socket 22 and the second locking seat 23, so that the second operation socket 22 is moved outward relative to the second locking seat 23 rapidly.

Accordingly, the male assembly 1 can be detached from the female assembly 2 rapidly, thereby facilitating the user operating the switch device to open the door 71 of the refrigerator 7. In addition, the user only needs to press the door 71 of the refrigerator 7 so as to open the door 71 of the refrigerator 7 easily and conveniently, thereby facilitating the user opening the door 71 of the refrigerator 7.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A switch device, comprising a male assembly, and a female assembly, wherein:
the male assembly includes a first fixing seat, a first operation socket, a first locking seat, and a retractable rod, wherein:
the first fixing seat of the male assembly has a side provided with a plurality of flexible locking hooks each having a distal end formed with a wedge-shaped catch portion;
the first operation socket of the male assembly is mounted on the first fixing seat and has a periphery formed with a plurality of positioning slots for movably mounting the catch portion of a respective one of the locking hooks of the first fixing seat;
the first locking seat of the male assembly is secured on the first fixing seat and has a side provided with a plurality of flexible locking pawls each having an outer wall formed with a groove and an inner wall formed with a catch portion;
the retractable rod of the male assembly is movably mounted in the first operation socket and the first fixing seat and has a first end formed with a first annular groove for slidably mounting the catch portion of each of the locking pawls of the first locking seat and a tapered second end formed with a tapered second annular groove;
the female assembly includes a second fixing seat, a second operation socket, and a second locking seat, wherein:
the second fixing seat of the female assembly has a side provided with a plurality of flexible locking hooks each having a distal end formed with a wedge-shaped catch portion;
the second operation socket of the female assembly is mounted on the second fixing seat and has a periphery formed with a plurality of positioning slots for movably mounting the catch portion of a respective one of the locking hooks of the second fixing seat; and
the second locking seat of the female assembly is secured on the second fixing seat and has a side provided with a plurality of flexible locking pawls each having an outer wall formed with a groove.

2. The switch device in accordance with claim 1, wherein the first fixing seat of the male assembly has a periphery formed with a plurality of locking recesses, and the first locking seat of the male assembly has a periphery formed with a plurality of positioning lugs each inserted into a respective one of the locking recesses of the first fixing seat.

3. The switch device in accordance with claim 1, wherein the first operation socket of the male assembly has an end face provided with a conical barrel having an inner wall formed with an axial hole and an outer wall formed with a tapered face, and each of the locking pawls of the first locking seat has a distal end formed with an inclined face rested on the tapered face of the conical barrel of the first operation socket.

4. The switch device in accordance with claim 3, wherein the retractable rod of the male assembly is movably mounted in the conical barrel of the first operation socket.

5. The switch device in accordance with claim 1, wherein the male assembly 1 further includes a C-shaped spring mounted in the groove of each of the locking pawls of the first locking seat for urging each of the locking pawls of the first locking seat radially inward.

6. The switch device in accordance with claim 1, wherein the retractable rod of the male assembly has an inside formed with a receiving chamber for receiving a first compression spring which is biased between a wall of the receiving chamber and the first fixing seat.

7. The switch device in accordance with claim 1, wherein the first fixing seat of the male assembly has a side provided with a cylinder, and the retractable rod of the male assembly is movably mounted in the cylinder of the first fixing seat.

8. The switch device in accordance with claim 1, wherein the second fixing seat of the female assembly has a periphery formed with a plurality of locking recesses, and the second locking seat of the female assembly has a periphery formed with a plurality of positioning lugs each inserted into a respective one of the locking recesses of the second fixing seat.

9. The switch device in accordance with claim 1, wherein the second operation socket of the female assembly has an end face provided with a conical barrel having an inner wall formed with an axial hole and an outer wall formed with a tapered face, and each of the locking pawls of the second locking seat has a distal end formed with an inclined face rested on the tapered face of the conical barrel of the second operation socket.

10. The switch device in accordance with claim 1, wherein the female assembly further includes a C-shaped spring mounted in the groove of each of the locking pawls of the second locking seat for urging each of the locking pawls of the second locking seat radially inward.

11. The switch device in accordance with claim 1, wherein the second fixing seat of the female assembly is provided with a cylinder, and the female assembly further includes an urging cap movably mounted in the cylinder of the second fixing seat and rested on the distal end of each of the locking pawls of the second locking seat, and a second compression spring mounted in the cylinder of the second fixing seat and biased between the urging cap and the second fixing seat.

12. The switch device in accordance with claim 1, wherein the inclined face of the distal end of each of the locking pawls of the second locking seat of the female assembly is locked in the second annular groove of the retractable rod of the male assembly.
